(19) United States
(12) Patent Application Publication
(10) Pub. No.: US 2026/0208909 A1
(43) Pub. Date: Jul. 23, 2026

(54) METHOD FOR OPERATING A LABELLING SYSTEM

(71) Applicant: Espera-Werke GmbH, Duisburg (DE)

(72) Inventors: Thorsten ZERFASS, Mülheim an der Ruhr (DE); Alexander SCHULZ, Mülheim an der Ruhr (DE)

(21) Appl. No.: 19/140,440

(22) PCT Filed: Nov. 28, 2023
(86) PCT No.: PCT/EP2023/083266

§ 371 Date: Jun. 18, 2025

(30) Foreign Application Priority Data
Dec. 19, 2022 (DE) 10 2022 133 864.9

(51) Int. Cl. B65C 9/40; B41J 2/335; B41J 3/407; B65C 1/02; B65C 9/46

(52) U.S. Cl. CPC B65C 9/40; B41J 2/335; B41J 3/4075; B65C 1/021; B65C 1/025; B65C 9/46; B65C 2009/407

(57) ABSTRACT

A method for operating a labelling system (1) having at least one labelling apparatus (2). The labelling apparatus is actuated to label individual packages (3) by means of a control arrangement (4) in order to apply a label (7) to a particular package in a labelling process. The labelling process includes determining weight values of the particular package by means of a weighing arrangement (5), dispensing a label by means of a dispensing arrangement (6), printing the label by means of a printer arrangement (9) depending on the weight values, and applying the label dispensed by the dispensing arrangement to the particular package by means of an application arrangement (13). Operating values captured during a particular labelling process are checked for compliance with a predefined completion criterion representative of a successful labelling process, and in the event of compliance with a completion criterion, this is stored in counter information.

### CROSS-REFERENCE TO RELATED APPLICATIONS

This application is a U.S. national stage of International App. No. PCT/EP2023/083266, filed Nov. 28, 2023, and claims priority to DE 10 222 133 864.9, filed Dec. 19, 2022.

### BACKGROUND OF INVENTION

### Field of Invention

The present invention relates to a method for operating a labeling system, and to a labeling system with a labeling device.

### Brief Description of Related Art

The labeling system in question here has at least one labeling device which is configured in particular as a pricing device. The labeling device is equipped inter alia with a weighing assembly, a dispensing assembly, and an application assembly for labels as functional units which are provided for the labeling of the individual packs. A printer assembly is provided for printing the labels, wherein the printing can also take place depending on a weight value determined by means of the weighing assembly.

In many cases, parameters such as the operating time of the labeling device or the quantity of resources used, for example the number of material strips of labels consumed, are employed as criteria for recording the labeling procedures implemented by the labeling devices. Based on these parameters, further process planning can be performed and additionally a calculation can be made of the costs accrued with operating the labeling devices.

A challenge here is that, when using parameters such as the operating time of the labeling device or the number of material strips consumed, the number of labeling procedures which have actually been performed can be determined only approximately. The number of successfully applied labels can vary considerably in the course of operation. In addition to different utilization rates and processing speeds, errors can occur in labeling procedures, as a result of which the number of labels consumed does not necessarily match the number of successfully applied labels.

The invention is based on the problem of specifying a method for operating a labeling system which allows largely accurate recording of the labeling procedures.

### BRIEF SUMMARY OF THE INVENTION

The above problem is achieved by operating values recorded in a respective labeling procedure being checked that they fulfill a predetermined completion criterion representing a successful labeling procedure, and storing the existence of a fulfilled completion criterion in a datum.

The essential thing is the fundamental idea that the functional units of the labeling devices have sensors for monitoring operation which determine operating values associated with the performance of the labeling. In addition to activating the functional units, the operating values can be used for checking whether a labeling procedure has run successfully. Based on the check, a counter datum, in which only those labeling procedures which have been classified as successful are taken into account, is created. The counter datum can accordingly be used for improved resource planning and invoicing.

It is specifically proposed that operating values recorded in a respective labeling procedure are checked that they fulfill a predetermined completion criterion representing a successful labeling procedure, and that the existence of a fulfilled completion criterion is stored in a counter datum.

Faulty application of the labels by means of the application assembly can here be a cause of the number of successful labeling procedures differing from the total number of labels consumed. A preferred embodiment therefore relates to operating values of an applicator, for example a static applicator and/or reciprocating stamp, of the application assembly, which are checked against the completion criterion. Operating values which are preferably to be used for the completion criterion are set forth in the specification and in one or more dependent claims.

In the further, likewise preferred embodiment, an advancing assembly for transporting the packs is provided, the operating values of which can be fed into the completion criterion. For example, an adequate matching of the speed of advance and an application speed of the applicator can be a requirement for successful application.

Also preferred is the embodiment, according to which a label sensor for recording the applied label is provided such that the result of the labeling procedure can be determined in a simple and reliable manner. Particularly preferred here is the use of a barcode scanner, whereby the labeling procedure can be evaluated by recording and checking a barcode on the label in a simple fashion.

In particular, the printed image generated by the printing, or an alignment of the label achieved by the application can be checked on the basis of the label sensor, for example a camera.

One or more other claims relate to the use of a printer sensor of the printer assembly, as a result of which faulty printing procedures can be identified on the basis of the operating values of the printer assembly. In particular, labeling procedures with wrongly printed labels are not taken into account in the counter datum or are at least marked accordingly.

Also of interest are disclosed embodiments according to which further data about the labeling procedure, such as a type of labeling procedure, is associated with the counter datum. As a result, in particular reporting of accrued resources and costs is facilitated.

The counter datum, in particular with the associated data mentioned, is, in the preferred embodiment, stored in a production control system or transmitted to the latter. Centralized recording of the counter datum for a plurality of labeling devices can hereby take place.

According to further teaching, which has separate meaning, a labeling system with a labeling device is disclosed and claimed, wherein the labeling system is preferably configured for performing the proposed method.

The essential thing here is that the labeling system is configured to check that operating parameters which have been recorded in a respective labeling procedure fulfill a predetermined completion criterion representing a successful labeling procedure and to store them in a counter datum. Reference should be made to all the explanations of the proposed method.

### BRIEF DESCRIPTION OF THE DRAWINGS

The invention will be explained in detail below on the basis of drawings which illustrate only exemplary embodiments and in which:

FIG. 1 shows a perspective illustration of the proposed labeling system for performing the proposed method, and

FIGS. 2a), 2b) and 2c) show schematic views of labels applied and printed in a labeling procedure.

### DETAILED DESCRIPTION OF THE INVENTION

The invention relates to a method for operating a labeling system 1. The labeling system 1 is equipped with at least one labeling device 2 for labeling individual packs 3 which is configured in particular as a pricing device.

The labeling device 2 has a control assembly 4 which activates functional units (yet to be explained) of the labeling device 2 for performing labeling procedures. One individual pack 3 is labeled in one labeling procedure. A sequence of labeling procedures for making up respective packs 3 preferably takes place in a labeling routine.

A weighing assembly 5 of the labeling device 2 serves to determine weight values of the respective pack 3. The weighing assembly 5 has a load cell which determines analog and/or digital weight values which are representative of the weight of the pack 3. The weight values are determined in particular on the basis of a measurement of the deformation of a support for the packs 3, for example via strain gauges, and/or on the basis of electromagnetic force compensation of the weight force of the respective pack 3.

A dispensing assembly 6 of the labeling device 2 is provided for dispensing a label 7 which can be configured as detachable from a strip of material 8. A label 7 which is detachable from a strip of material 8 means in particular a label 7 which is applied detachably by its adhesive surface on a carrier strip which forms the strip of material 8 and can be made, for example, from paper and/or plastic. It is likewise possible that the label 7 is produced by separating a section of a printable or printed strip of material 8, for example by cutting and/or tearing the strip of material 8. In particular, labels 7 configured as adhesive labels are used which already have an adhesive surface by means of which they are fastened detachably on the strip of material 8. The use of labels 7 with no adhesive and which are provided with an adhesive surface or are applied to an adhesive surface on the respective pack 3 only later is also conceivable.

A printer assembly 9 of the labeling device 2 is provided for printing the label 7, wherein printing of the label can take place in principle on the strip of material 8 and/or after the label 7 has been detached from the strip of material 8, as well as before, after, or during the application of the label 7 to the respective pack 3. A printer assembly 9 configured for thermal printing, in particular thermal direct printing or thermal transfer printing, is provided in the present case and preferably. The label 7 is printed depending on the weight values. For example, the label 7 is provided with a weight datum 10 during the printing and/or an individual price 12 to be associated with the pack 3 is determined on the basis of a base price 11 and printed on the label 7.

In addition, the labeling device 2 has as a further functional unit an application assembly 13 for applying the dispensed label 7 to the respective pack 3, in the present case in a common housing with the dispensing device 6. The dispensed label 7 is preferably received by a stamp, which is configured in the present case and preferably, as a reciprocating stamp 14, and is applied to the respective pack 3. In particular, the stamp has a blowing head for sucking up and blowing off the label 7. During the application, the reciprocating stamp 14 here performs a movement in a transporting direction of the packs 3 in order to enable labeling of moving packs 3. The label 7 can be applied by means of the application assembly 13 by the label 7, touching the pack 3, being pressed against it. Additionally or alternatively, it is conceivable that the label 7 is applied contactlessly, for example by the blowing head of the stamp blowing off the label 7, onto the pack 3, by generating a blast of compressed air directed at the pack 3.

A labeling procedure for a pack 3 comprises at least the actions performed by the abovementioned functional units activated by means of the control assembly 4:
determining weight values of the respective pack 3 by means of a weighing assembly 5;
dispensing a label 7 by means of a dispensing assembly 6;
printing the label 7 by means of a printer assembly 9 depending on the weight values; and
applying the label 7 dispensed by the dispensing assembly 6 to the respective pack 3 by means of an application assembly 13.

The labeling procedure is preferably performed repeatedly for a plurality of packs 3 in a labeling routine.

It is essential then that operating values recorded during a respective labeling procedure are checked that they fulfill a predetermined completion criterion representing a successful labeling procedure and the existence of a fulfilled completion criterion is stored in a counter datum.

The labeling device 2, and in particular the abovementioned functional units the weighing assembly 5, the dispensing assembly 6, the printer assembly 9, and/or the application assembly 13, in the present case and preferably has sensors 15 which monitor the functioning of the labeling device 2 and are used as a basis for activation by means of the control assembly 4. Operating values which further serve to evaluate the respective labeling procedure are here recorded by means of the sensors 15.

The completion criterion generally represents a successful labeling procedure which is mapped in the operating values. For example, a labeling procedure is only considered successful when an operating value or a plurality of operating values lies or lie within a predetermined value range. Operating values can also directly map a faulty state, wherein the labeling procedure is considered successful only when such an operating value indicates a faulty labeling procedure.

The counter datum is indicative of the number of labeling procedures considered successful according to the check of the completion criterion. In a simple embodiment, the counter datum includes a numerical value which is increased incrementally by the existence of a fulfilled completion criterion and thus by the existence of a labeling procedure which has been considered successful. It is also conceivable that the total number of labeling procedures is recorded by the counter datum, wherein, however, the number of labeling procedures which have been evaluated as inadequate by not fulfilling the completion criterion is subtracted from the total number.

One aspect for a successful labeling procedure is here an optimal application of the labels 7 by means of the application assembly 13. In one preferred embodiment, it is provided that the completion criterion refers to operating values of an applicator of the application assembly 13. In an embodiment not illustrated, it is in principle possible for a static applicator to be provided, wherein the pack 3 is moved relative to the applicator in order to apply the label 7. By virtue of the movement of the pack 3 at the applicator, a label 3 adhering to the pack 3 can be detached from a strip of material 8, for example in an unrolling movement. In particular, a static applicator can be integrated into the dispensing assembly 6.

In the preferred embodiment illustrated, a movable applicator is provided which is configured to execute an application movement relative to the pack 3. The applicator is configured in the present case and preferably as a reciprocating stamp 14.

The interaction of the applicator with the pack 3 is particularly important during the application. The completion criterion can refer to the presence of a label 7 on the applicator when the pack 3 is acted upon by the application assembly 13. The presence can be mapped by an operating value. Acting on the pack 3 here refers to the interaction between the applicator and the pack 3, which can be performed so that they touch each other or contactlessly.

The completion criterion can refer to the application pressure of the applicator. In the case of a static applicator, the application pressure is to be understood in particular as the contact pressure of the pack 3 on the applicator. The application pressure is to be understood in the case of a moving applicator as, for example, the compressed air used by a reciprocating stamp 14 configured as a pneumatic reciprocating stamp. For example, an inadequate reduced pressure when sucking up the label 7 and/or too little compressed air when blowing off the label 7 can be an indicator for faulty application of the label 7. The same applies for an application height of the applicator for the respective pack 3, in particular the stroke height of the reciprocating stamp 14 which refers to the position of the applicator relative to the surface of the respective pack 3. Unintended collisions between the blowing head and the pack 3 can also be identified in the movement of the reciprocating stamp 14 such that it can be concluded that the label 7 has been applied inadequately or is absent.

An advancing assembly 16 for transporting respective packs 3 is in the present case and preferably provided as a further functional unit. The advancing assembly 16 is preferably a belt conveyor or a roll conveyor, possibly also at least one robot arm, for moving the respective packs 3. The advancing assembly 16, in the present case the belt conveyor, in the present case and preferably has at least one transport belt 17 via which the respective packs 3 are transported in the transporting direction.

The labeling procedure preferably further comprises the action of transporting the respective pack 3 by means of the advancing assembly 16 at an advancing speed when applying the label 7. The completion criterion can refer to a predetermined match between an application speed of the reciprocating stamp 14 and the advancing speed and/or an alignment of the respective pack 3 on the advancing assembly 16.

A predetermined matching of the speeds is in particular to be understood as meaning that the difference between the speeds does not exceed a predetermined maximum deviation, which can be a prerequisite for successful application. The advancing speed can be determined via a movement sensor and/or via drive values such as drive current and drive voltage of the advancing assembly 16. The application speed of the reciprocating stamp 14 can be understood as meaning the speed of the reciprocating stamp 14 in the transporting direction at the time of application.

The alignment of the pack 3 on the advancing assembly 16 refers to the position of the pack 3 and in particular the orientation of the surface of the pack 3 relative to the label 7 to be applied. For example, a pack 3 placed askew on the advancing assembly 16 can cause the label 7 to be applied with an angular deviation or on the wrong side of the pack 3. A pack sensor 18 is provided in this case and preferably which is preferably configured as a camera and determines image data relating to the packs 3 transported by means of the advancing assembly 16. The pack sensor 18 is in this case and preferably provided upstream of the application assembly 13 in the transporting direction.

The completion criterion can refer to the spacing between successive packs 3 transported by the advancing assembly 16 and/or to the number of packs 3 transported per unit time. Packs 3 transported on the advancing assembly 16 can be recorded by sensors, preferably via a light barrier or the like. If, for example, there is too small a spacing between the packs 3 for the advancing speed, for example when is recorded that the spacing is below a predetermined minimum spacing between the packs 3 and in particular in the case of packs 3 which are lying next to one another, the absence of a successful labeling procedure for at least one of the packs 3 can be assumed.

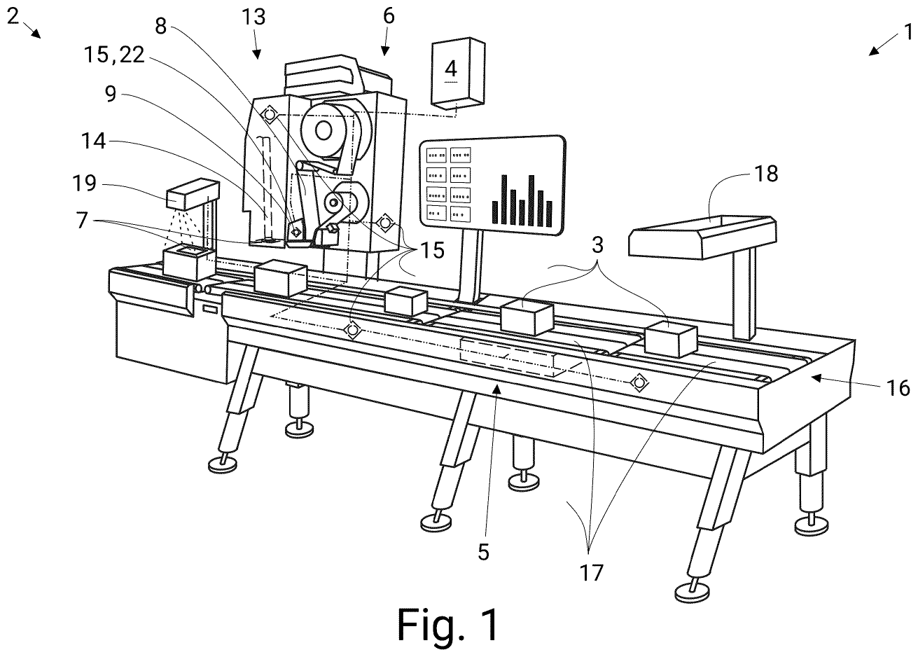

In addition, it is shown in FIG. 1 in a preferred embodiment that the labeling device 2 has a label sensor 19 for the applied, in particular printed, label 7. The completion criterion is here checked by means of the label sensor 19 at least partly on the basis of recording of the label 7.

The label sensor 19 preferably has a barcode scanner which records a barcode situated, in particular printed, on the label 7. Checking the completion criterion includes comparing the recorded barcode with a barcode specification for the pack 3. The barcode scanner can for this purpose have a sensor control system which decodes the recorded barcode. The barcode specification can here refer to at least part of the decoded datum included in the recorded barcode. The recorded barcode, and hence the application of the label, can be categorized as correct by the comparison. It can likewise be established that although the barcode is readable, it does not match the barcode specification or has a differing format. The barcode can furthermore be categorized as unreadable.

The labeling procedure is preferably taken into account in the counter datum only in the case of a barcode categorized as correct.

Also conceivable is an embodiment of the label sensor 19 as a camera or the like. The result of the labeling procedure can be determined by means of the label sensor 19, in particular via image data.

It is preferably provided that the completion criterion refers to printing of the label 7 by the printer assembly 9, in particular the existence of printing errors and/or an alignment of the printed image generated.

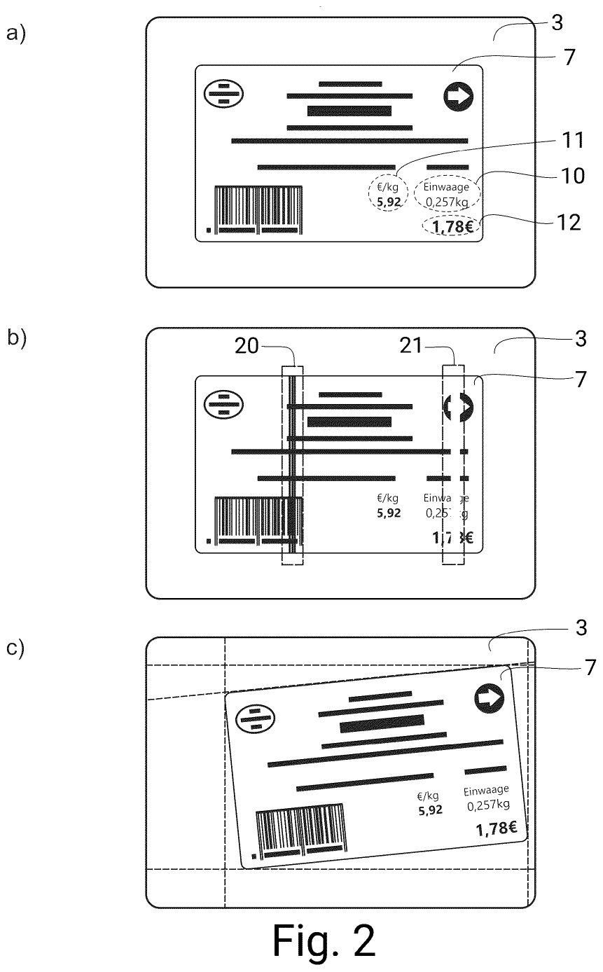

FIG. 2a) shows by way of example an optimally printed and applied label 7 on a pack 3. Illustrated in FIG. 2b), in contrast, is a label 7 which, although it is optimally applied, does have some printing errors. A printing error which is caused in the present case by a wrongly activated pixel, in the present case made black throughout, is shown in the region 20. In contrast, a non-standard pixel can be seen in the region 21 such that part of the printed image is missing here. The alignment of the printed image refers in particular to the accuracy of centering of the printed image on the surface of the label 7, which can likewise be identified via image data.

The completion criterion can furthermore refer to the alignment of the applied label 7 on the pack 3, which is indicated in FIG. 2c). The alignment of the applied label 7 refers here to the intended placement of the label 7 inside a predetermined region of the pack 3. The alignment can also refer to skewing of the label 7 relative to a predetermined angular position.

The results of labeling procedures shown in FIG. 2b) and c) can result in the completion criterion not being fulfilled, for example identified by operating values of the barcode scanner or the camera, such that the corresponding labeling procedures are not taken into account in the counter datum. Accordingly, only those labels 7 according to FIG. 2a which have been applied and printed in accordance with a specification mapped via the completion criterion are included in the counter datum.

The completion criterion can moreover refer to adhesion of the label 7 on the pack 3 and/or the lack of a label 7. For example, the label sensor 19 is used to identify only partially effected adhesion, for example because of an inadequate adhesive surface, or a label 7 which has been applied such that it is folded. The lack of the label 7 can likewise be recorded simply via the label sensor 19, for example the barcode scanner.

It is provided in a further embodiment that the printer assembly 9 has a printer sensor 22 which records operating values of the printer assembly 9 during printing of the label 7, and that the completion criterion refers to the operating values of the printer assembly 9.

The printer assembly 9 is preferably configured for thermal printing, wherein the label 7 changes color, in particular turns black, at the location at which it is exposed to heat by point-wise exposure to heat. The point-wise exposure to heat is effected by one or more rows of heating resistors which are arranged in the thermal strip of the thermal print head. The functioning of the heating resistors can be monitored by means of the printer sensor 22. If there is a deviation in an electrical resistance value of a heating resistor, it can be concluded that the respective pixel (dot) is non-standard.

The printer assembly 9 can have a counter-pressure element, in particular in the form of an immovable bar or rotatable roller, wherein an insertion gap is formed between the thermal strip and the counter-pressure element. Position values of the counter-pressure element which are determined, for example, via a position sensor can be monitored and compared in particular with a dimension of the insertion gap, predetermined for the respective label type.

The counter datum can be associated with further data about the respective labeling procedures, for example the time at which the respective labeling procedure is performed. The associated data can also be formed by operating values and/or by quantities derived from the operating values.

In one embodiment, it is provided that a labeling procedure type, in particular on the basis of a label type of the applied label 7 and/or a print type of the printing performed on the label 7, is associated with the respective labeling procedure on the basis of a predetermined association protocol and is stored in particular for the counter datum.

Labels 7 of different formats, thickness, materials, and the like are, for example, differentiated by the label type. The printing of the label 7 is, for example, categorized by the print type, for example according to the respective printed image, a proportion of pixels over the whole area of the printed image which have been made black, or the like.

It is furthermore provided in the present case and preferably that quality measurement values recorded by at least one sensor, in particular at least one of the abovementioned sensors 15, of the labeling device 2 with reference to the labeling procedure are checked that they fulfill a predetermined quality criterion, and that a datum about fulfilling the quality criterion and/or the degree to which it is fulfilled is associated with the labeling procedure, preferably that the datum about fulfilling the quality criterion and/or the degree to which it is fulfilled is stored for the counter datum.

Whilst checking the completion criterion yields a binary datum (labeling procedure successful/unsuccessful), more granular categorization of the labeling procedure can be effected via the quality criterion. The quality criterion can here refer to one or more actions of the labeling procedure, for example to the degree of matching between the printed image generated and a printed image template and the accuracy of the alignment of the label 7 on the respective pack 3. In particular, the quality criterion allows more granular analysis and documentation of the entirety of the labeling procedures performed in a labeling routine.

In one embodiment, it is provided that a price datum of a labeling routine is determined on the basis of a predetermined calculation protocol depending on the counter datum, preferably furthermore depending on the associated labeling procedure type and/or on the associated degree to which the quality criterion has been fulfilled, and is associated with the respective labeling procedure, preferably that the price datum is stored for the counter datum.

The costs specified for a respective label type are, for example, stored in the calculation protocol. It is additionally conceivable that the price datum to be associated with a labeling procedure is dependent on the quality criterion.

It is furthermore in the present case and preferably provided that the counter datum is stored in a production control system (not illustrated here) of the labeling system 1 or that the counter datum is stored in the control assembly 4 and is transmitted to the production control system, in particular with the associated labeling procedure type, the associated degree to which the quality criterion has been fulfilled and/or the associated price datum.

The production control system can be part of a production management system which serves to amalgamate data from different labeling devices 2. The production control system in particular supervises the control assemblies 4 of a plurality of labeling devices 2. In one embodiment, the production control system is implemented via a cloud which has at least one cloud server.

A labeling system 1 with a labeling device 2 is proposed, wherein the labeling device 2 is configured to be activated in a labeling routine for labeling, in particular pricing, individual packs 3 by means of a control assembly 4 of the labeling device 2 in order to apply a label 7 to a respective pack 3 in a labeling procedure, wherein the labeling device 2 has:
a weighing assembly 5 for determining weight values of the respective pack 3, a dispensing assembly 6 for dispensing a label 7, a printer assembly 9 for printing the label 7 depending on the weight values, and an application assembly 13 for applying the label 7 dispensed by the dispensing assembly 6 to the respective pack 3.

The essential thing here is that the labeling system 1 is configured to check whether operating parameters recorded in a respective labeling procedure fulfill a predetermined completion criterion representing a successful labeling procedure and to store the existence of a fulfilled completion criterion in a counter datum.

Reference should be made to all the explanations of the proposed methods.

1-13. (canceled)

14. A method for operating a labeling system with at least one labeling device, wherein the labeling device is activated by means of a control assembly of the labeling device in order to apply a label to a respective pack in a labeling procedure, wherein the labeling procedure comprises:
determining weight values of the respective pack by means of a weighing assembly;
dispensing the label by means of a dispensing assembly;
printing the label by means of a printer assembly depending on the weight values; and
applying the label dispensed by the dispensing assembly to the respective pack by means of an application assembly;
wherein operating values recorded in a respective labeling procedure are checked that they fulfill a predetermined completion criterion representing a successful labeling procedure, and wherein the existence of a fulfilled completion criterion is stored in a datum.

15. The method as claimed in claim 14, wherein the completion criterion refers to operating values of an applicator of the application assembly for applying the label.

16. The method as claimed in claim 15, wherein the applicator is configured as a static applicator.

17. The method as claimed in claim 15, wherein the applicator is a movable applicator.

18. The method as claimed in claim 17, wherein the movable applicator is a reciprocating stamp.

19. The method as claimed in claim 15, wherein the completion criterion refers to the presence of a label on the applicator when the pack is acted upon by the application assembly, an application pressure of the applicator, an application height of the applicator for the respective pack when the label is being applied, and/or the absence of a collision between the applicator and the respective pack.

20. The method as claimed in claim 18, wherein the completion criterion refers to a stroke height of the reciprocating stamp.

21. The method as claimed in claim 18, wherein the labeling procedure further comprises transporting the respective pack by means of an advancing assembly at an advancing speed when the label is being applied, and wherein the completion criterion refers to a predetermined match between an application speed of the reciprocating stamp and the advancing speed and/or an alignment of the respective pack on the advancing assembly.

22. The method as claimed in claim 14, wherein the labeling device has a label sensor, for recording the applied, printed label, and wherein the completion criterion is checked at least partially on the basis of the recording of the label by means of the label sensor.

23. The method as claimed in claim 22, wherein the label sensor is an optical sensor.

24. The method as claimed in claim 22, wherein the label sensor has a barcode scanner which records a barcode printed on the label, and wherein the checking of the completion criterion includes a comparison of the recorded barcode with a barcode specification for the respective pack.

25. The method as claimed in claim 14, wherein the completion criterion refers to printing of the label by the printer assembly, the alignment of the applied label on the respective pack, adhesion of the label on the respective pack and/or the lack of a label on the respective pack.

26. The method as claimed in claim 14, wherein the completion criteria refers to the existence of printing errors and/or an alignment of the printed image generated.

27. The method as claimed in claim 14, wherein the printer assembly has a printer sensor which records operating values of the printer assembly during printing of the label, and wherein the completion criterion refers to the operating values of the printer assembly.

28. The method as claimed in claim 27, wherein the printer assembly has a thermal print head and heating resistors of the thermal print head and/or position values of a counter-pressure element of the thermal print head are monitored by means of the printer sensor.

29. The method as claimed in claim 14, wherein a labeling procedure type is associated with the respective labeling procedure on the basis of a predetermined association protocol and is stored for counter datum.

30. The method as claimed in claim 29, wherein the labeling procedure type is based on a label type of the applied label and/or a print type of the printing performed on the label.

31. The method as claimed in claim 29, wherein quality measurement values recorded by at least one sensor of the labeling device with reference to the labeling procedure are checked that they fulfill a predetermined quality criterion, and wherein a datum about fulfilling the quality criterion and/or the degree to which it is fulfilled is associated with the labeling procedure.

32. The method as claimed in claim 31, wherein the datum about fulfilling the quality criterion and/or the degree to which it is fulfilled is stored for the counter datum.

33. The method as claimed in claim 29, wherein a price datum of the labeling routine is determined on the basis of a predetermined calculation protocol depending on the counter datum, and is associated with the respective labeling procedure.

34. The method as claimed in claim 33, wherein the price datum of the labeling routine further depends on the associated labeling procedure type and/or on the associated degree to which the quality criterion has been fulfilled.

35. The method according to claim 34, wherein the price datum is stored for the counter datum.

36. The method as claimed in claim 29, wherein the counter datum is stored in a production control system of the labeling system or wherein the counter datum is stored in the control assembly and is transmitted to the production control system with the associated labeling procedure type, the associated degree to which the quality criterion has been fulfilled and/or the associated price datum.

37. A labeling system with a labeling device, wherein the labeling device is configured to be activated in a labeling routine by means of a control assembly of the labeling device in order to apply a label to a respective pack in a labeling procedure, wherein the labeling device comprises:
a weighing assembly for determining weight values of the respective pack;
a dispensing assembly for dispensing the label;
a printer assembly for printing the label depending on the weight values; and
an application assembly for applying the label dispensed by the dispensing assembly to the respective pack; and
wherein the labeling system is configured to check whether operating parameters recorded in a respective labeling procedure fulfill a predetermined completion criterion representing a successful labeling procedure and to store the existence of a fulfilled completion criterion in a counter datum.
